(19) United States
(12) Patent Application Publication
(10) Pub. No.: US 2025/0117170 A1
(43) Pub. Date: Apr. 10, 2025

(54) PRINTING SYSTEM, INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: SHOGO HIGASHI, Kanagawa (JP)

(21) Appl. No.: 18/908,428

(22) Filed: Oct. 7, 2024

(30) Foreign Application Priority Data
Oct. 10, 2023 (JP) 2023-175152

(51) Int. Cl. G06F 3/12

(52) U.S. Cl. CPC G06F 3/126; G06F 3/1207; G06F 3/1259

(57) ABSTRACT

A scheduler program calculates, based on the type of the medium designated as a print job as a target, a time until the printing on the print job is completed, and outputs the calculated time to a predetermined output destination. With no type of the medium designated in the print job as the target, the scheduler program calculates the time until the printing on the print job is completed based on a previously set reference medium type, and outputs the calculated time to the output destination. With the type of the medium determined based on a detection result of the medium fed in the print job, the scheduler program updates the time until the printing is completed, the time being output to the output destination based on the type of the medium.

### BACKGROUND

### Field

The present disclosure relates to a printing system, an information processing apparatus, a method for controlling an information processing apparatus, and a storage medium.

### Description of the Related Art

In the field of commercial printing, it is important to avoid stopping printing as much as possible, that is, to avoid a downtime, to produce high-quality print output results and to avoid reducing outputs of products. To prevent a downtime, it is desirable for operators to understand a printing status and perform operations, such as replenishing and replacing consumables, such as a medium and toner, managing print jobs, editing job tickets, transporting output products, and post-processing finishing, such as cutting and binding, at an appropriate timing. In light of this, various methods are proposed to enable the operator to take necessary measures before a downtime occurs. Japanese Patent Application Laid-Open No. 2015-000557 discusses a technique in which a time for printing is accurately predicted based on information, such as the type of a medium used for printing and the current temperature of a fixing unit, and a predicted printing completion time and a timing when a consumable needs to be replenished or replaced are displayed to an operator.

On the other hand, there can be situations where the type of a medium (for example, a sheet) to be used is not determined in advance, such as when a job allowing the type of a medium to be determined with a sensor that the medium passes after the sheet is fed is to be executed. In such a situation, for example, it is difficult to determine the type of a medium during the period from when a job is started to when the medium is fed. That is, under such circumstances, even if a job is accepted, it is difficult to calculate the printing time until the job is started and the medium is fed, making it difficult to present the print completion time to the user (for example, the operator) in advance.

### SUMMARY

In view of the above issue, the present disclosure is directed to enabling presenting a predicted time until printing is completed in a more suitable form even in a situation where the type of a medium to be used for printing is undetermined.

According to an aspect of the present disclosure, a printing system includes a reception unit configured to receive a print job in which a type of a medium to be used in printing is able to be designated, a schedule management unit configured to calculate, based on the type of the medium designated in the print job, a time until the printing on the print job is completed, and output the calculated time to a predetermined output destination, and a detection unit configured to detect a type of a medium fed by a feeder. When there is no type of medium designated in the print job, the schedule management unit calculates the time until the printing on the print job is completed based on a previously set reference medium type, and outputs the calculated time to the output destination. When the type of medium is determined based on a detection result of the medium fed in the print job, the schedule management unit updates, based on the type of the medium, the time until the printing is completed and the time being output to the output destination.

Further features of the present exemplary embodiment will become apparent from the following description of exemplary embodiments with reference to the attached drawings.

### BRIEF DESCRIPTION OF THE DRAWINGS

FIG. 1 illustrates an example of the system configuration of a printing system.

FIG. 2 is a functional block diagram illustrating an example of the functional configuration of a Multifunction Peripheral (MFP).

FIG. 3 illustrates an example of the hardware configuration of a digital front end (DFE).

FIG. 4 illustrates an example of the software configuration of the MFP.

FIG. 5 illustrates an example of a software configuration of the DFE.

FIG. 6 is a flowchart illustrating an example of processing of the DFE.

FIG. 7 is a flowchart illustrating an example of processing of the DFE.

FIG. 8 is a diagram illustrating an example of a setting screen of the DFE.

FIG. 9 is a diagram illustrating an example of a management table for times for temperature adjustment of a fixing unit.

FIGS. 10A to 10F are diagrams illustrating an example of a setting screen of the DFE.

FIGS. 11A to 11C are diagrams illustrating an example of a management screen of the DFE.

FIGS. 12A to 12D are diagrams illustrating an example of a management screen of the DFE.

FIGS. 13A to 13D are diagrams illustrating an example of a setting screen of the DFE.

FIG. 14 is a flowchart illustrating an example of processing of the DFE.

FIG. 15 is a diagram illustrating an example of a setting screen of the DFE.

FIG. 16 is a diagram illustrating an example of a setting screen of the DFE.

FIG. 17 is a diagram illustrating an example of a setting screen of the DFE.

FIG. 18 is a diagram illustrating an example of a setting screen of the DFE.

### DESCRIPTION OF THE EMBODIMENTS

Exemplary embodiments of the present disclosure will be described in detail with reference to the accompanying drawings.

In this specification and drawings, components having substantially the same functional configurations are denoted by the same reference numerals and redundant explanations will be omitted.

A first exemplary embodiment of the present disclosure will be described.

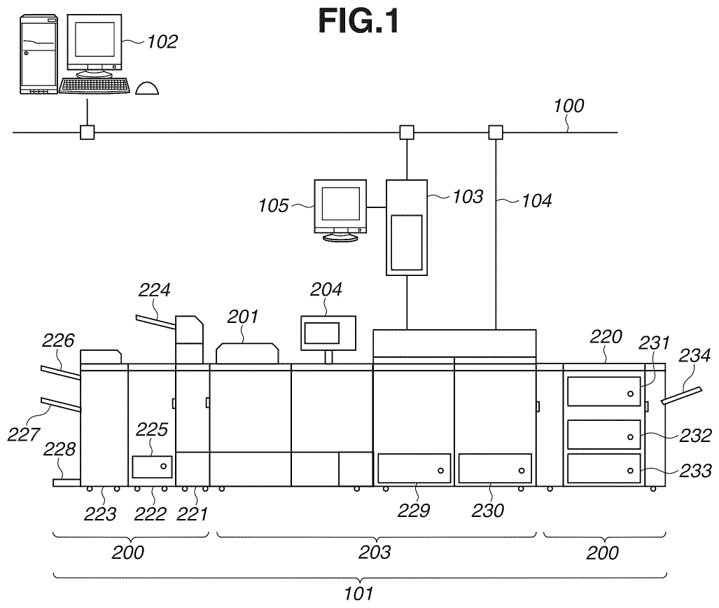

First, with reference to FIG. 1, an example of the system configuration of a printing system according to the present exemplary embodiment will be described. In the present exemplary embodiment, a multifunction peripheral (MFP) 101 is applied as an example of an image forming apparatus, and a personal computer (PC) 102 is applied as an example of an informing processing apparatus. The MFP 101 and the PC 102 are connected to each other via a network 100 to allow communication with each other.

While an example illustrated in FIG. 1 illustrates an example in which one information processing apparatus is provided in the printing system, this does not necessarily limit the configuration of the printing system according to the present exemplary embodiment. For example, a plurality of information processing apparatus can be communicably connected to the MFP 101 via the network 100. In another example, the image forming apparatus can also serve as the information processing apparatus. In image forming processing executable by the MFP 101 alone, such as printing by a copy job or a save job, a configuration can be employed with no intervention of the information processing apparatus connected via the network 100.

First, the PC 102 will be described. The PC 102 is implemented as a device capable of executing various types of programs, such as an application program for submitting a print job.

In the present exemplary embodiment, various types of applications, such as a printer driver and workflow software that have the function of converting print data to be printed into data defined in a printer language compatible with MFP 101, are installed on PC 102.

This configuration allows a user to issue a print instruction to a printer driver and workflow software via various types of applications. The printer driver and the workflow software convert data output by an application, based on a received print instruction, into print data that can be interpreted by the MFP 101, and transmits the print data to the MFP 101 connected to the network 100.

In the present exemplary embodiment, an example of a case where a PC is applied as an example of the information processing apparatus is illustrated, but there is no limitation as long as the information processing apparatus has a communication function, and for example, a mobile information terminal, such as a smartphone or a tablet terminal, can also be applied. As long as print data can be transmitted to the image forming apparatus, the method for transmitting the data is not particularly limited.

In a specific example, print data can be transmitted to the image forming apparatus via a printing application or driver. In another example, print data can be transmitted to the image forming apparatus via a so-called network service, such as a cloud service.

The MFP 101 will now be described. The MFP 101 has a reading function of reading an image on a sheet (an original to be read) and a printing function of printing an image on a sheet (a medium such as printing paper). The MFP 101 also has post-processing functions, such as binding a plurality of sheets printed thereon with images, aligning a plurality of sheets, and separating a plurality of sheets into a plurality of trays as discharge destinations. The sheets can include a medium (paper) such as plain paper, thick paper, and coated paper, and film.

In the present exemplary embodiment, an example in which the MFP 101 is applied as the image forming apparatus will be described, but instead of the MFP 101, an image forming apparatus, such as a printer not having a reading function, can be applied. In the present exemplary embodiment, as an example, the image forming apparatus includes various types of configurations described below.

A digital front end (DFE) 103 is a device configured to mainly process print job data to be input to the MFP 101. Specifically, the DFE 103 provides functions as a kind of server device configured to correct, edit, perform high-speed RIP processing on, store, and manage print job data received from the PC 102.

The above-mentioned functions of the DFE 103 can be carried out as a part of the functions of the main body of the MFP 101. In a specific example, the configuration corresponds to a configuration that the MFP 101 itself provides the functions of the DFE 103 to an external device. In such a case, it is possible for the PC 102 to regard the DFE 103 as providing the functions of the MFP 101 in place of the MFP 101 via the network 100.

The DFE 103 can be provided with various types of input/output devices, such as a monitor 105, similar to those provided in the PC 102. Even if the MFP 101 is equipped with the DFE 103 implemented as an associated device, the MFP 101 can be configured to be directly connectable to the network 100 via the network cable 104.

The MFP 101 is configured such that a plurality of devices having different roles is interconnected to allow complex sheet processing. Each component of the MFP 101 will now be described.

The printer unit 203 forms (prints) an image using toner on a medium (sheet) fed from a paper feed unit based on image data. A configuration and an operating principle of the printer unit 203 are as follows.

A light beam, such as a laser beam, modulated according to image data is reflected by a rotating polygon mirror (such as a polygon mirror) and is projected on the photosensitive drum as scanning light. This laser beam forms an electrostatic latent image on the photosensitive drum, the latent image is developed with toner, and the toner image is transferred to a sheet stuck on a transfer drum. This series of image forming processes is carried out in sequence on yellow (Y), magenta (M), cyan (C) and black (K) toners, and a full-color image is formed on the sheet. In addition to these four colors, a configuration can be applied that allows transfer of toners called special colors, transparent toner, and the like. The sheet on the transfer drum on which the full-color image is formed is then transported to a fixing device. The fixing device includes a roller, and a belt, and includes a heat source, such as a halogen heater in the roller, and melts the toner as transferred toner image on the sheet by heat and pressure, fixing such toner to the sheet.

The MFP 101 according to the present exemplary embodiment is configured so that an appropriate print speed mode to be applied by the printer unit 203 during printing is selected depending on the type of sheet used in printing processing. Specifically, fixing processing is subject to the applicable print speed restrictions depending on a sheet type, a grammage, and the like, and thus, the MFP 101 may have a function of switching the print speed mode depending on the sheet type and the grammage. By switching the print speed mode, for example, the fixing temperature of the image forming unit is changed, and various adjustments associated with the speed change are performed.

The MFP 101 according to the present exemplary embodiment is provided with an operation unit 204 mounted to the upper surface of the printer unit 203. The operation unit 204 provides various types of interfaces for a user to perform various types of settings and operations of the printer unit 203 according to the present exemplary embodiment. The monitor 105 can be configured to have the function of the operation unit 204 instead of the operation unit 204.

A large-capacity paper feeder 220 is a paper feeder detachable from printer unit 203. Such a paper feeder includes a plurality of paper feed units (for example, paper feed units 231, 232, 233, and 234). This configuration allows the printer unit 203 to execute printing processes on a large volume of sheets.

An inserter 221 is a device used when inserting sheets not involving image formation between products as sheets (printed matter) created by the printer unit 203. In the example illustrated in FIG. 1, a device is provided which has a configuration including a tray 224.

A punch device 222 is a device provided for the purpose of performing processing, such as punching holes in sheets supplied by the printer unit 203 or the inserter 221.

In the example illustrated in FIG. 1, a configuration in which an internal component called a die is replaceable is illustrated. Therefore, in the example illustrated in FIG. 1, the punch device 222 is provided with a door 225 for die replacement.

A processing device 223 is a device provided for stapling a bundle of a plurality of sheets. Stapling categories include corner binding, two-point binding, and saddle binding, and binding processing in a form corresponding to an instruction from a user is applied. The discharge destination of the processed product can be controlled depending on the category of the stapling. For example, in the example illustrated in FIG. 1, a configuration is employed in which in corner binding or two-point binding, products are discharged to trays 226 and 227, and in saddle binding, products are discharged to a tray 228.

The MFP 101 illustrated in FIG. 1 can be roughly divided into three sections, with the printer unit 203 as a boundary. For example, in FIG. 1, the device arranged on the right of the printer unit 203 is called paper a feeding device. The paper feeding device plays a role of continuously supplying sheets loaded inside to the printer unit 203 at appropriate timings. The device also detects amounts of remaining sheets loaded inside. The printer unit 203 also includes paper feed units (for example, paper feed units 229 and 230) therein, and can perform the same function as the paper feeding device. For the sake of description, these paper feeding units included in the printer unit 203 will also be referred to as paper feeding devices.

On the other hand, in FIG. 1, the device arranged on the left of the printer unit 203 is called a sheet processing device. Such a sheet processing device is also called a post-processing device. The sheet processing device performs various types of processing on sheets after printing processing, or performs processing, such as stacking. In the present disclosure, the above-mentioned paper feeding device and sheet processing device are collectively referred to as a sheet processing device 200.

An example of a configuration of the MFP 101 according to the present exemplary embodiment will now be described, focusing mainly on the software configuration.

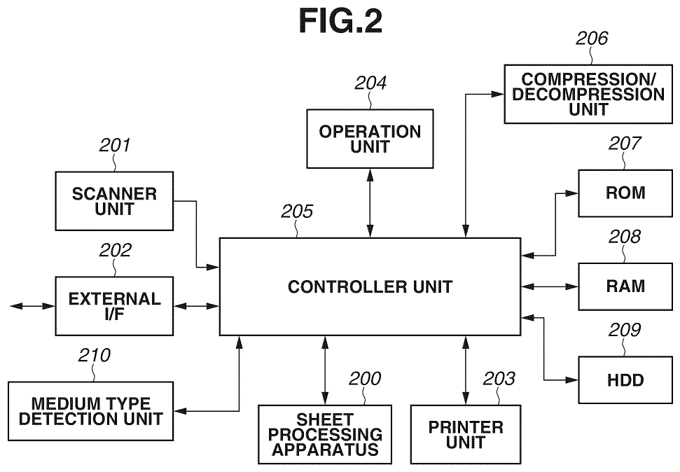

FIG. 2 is a functional block diagram illustrating an example of a functional configuration of the MFP 101 according to the present exemplary embodiment. In the example illustrated in FIG. 2, when the MFP 101 is viewed as a system unit, components are separated focusing on key points, and thus, some of the series of components illustrated in FIG. 1 are integrated or omitted from the illustration.

The MFP 101 includes therein a non-volatile memory, such as a hard disk drive (HDD) 209 capable of storing data about a plurality of jobs to be processed. In the present exemplary embodiment, an example of a case where the HDD is used as a non-volatile memory is illustrated, but another storage device may be used instead of the HDD as long as the storage device is substantially similar large-capacity and non-volatile storage devices.

The MFP 101 has a copy function of storing data received from the scanner 201 in the HDD 209, reading the data from the HDD 209, and causing the printer unit 203 to print the data. The MFP 101 also has a printing function for storing job data received from an external device via an external interface (I/F) 202, which is an example of a communication unit, in the HDD 209, reading the job data from the HDD 209, and causing the printer unit 203 to print the job data. The MFP 101 is implemented as a multi-function processing apparatus (also called an MFP, image forming apparatus) equipped with a plurality of such functions. The MFP 101 according to the present exemplary embodiment can be compatible with either color printing or monochrome printing.

The scanner 201 reads an original image, performs image processing on the image data obtained by reading the original, and outputs the processed image data to a predetermined output destination.

The external I/F 202 transmits and receives various data, such as image data, to and from a facsimile, a network-connected device, an external dedicated device, and the like.

The HDD 209 can also store various types of management information stored, updated as appropriate, and managed by the MFP 101.

The MFP 101 also includes the printer unit 203 configured to execute printing processing, based on data about a job to be printed stored in the HDD 209.

The MFP 101 also includes the operation unit 204 including a display unit corresponding to an example of a user interface unit.

A controller unit (control unit) 205, which is an example of a control unit provided in the MFP 101, is implemented as a processor, such as a central processing unit (CPU), and provides the overall control of the processing and operation of various types of units provided in the MFP 101.

A read only memory (ROM) 207 stores control programs for carrying out various functions of the MFP 101 according to the present exemplary embodiment, including programs for executing various types of processing of flowcharts described below, which are executed by the controller unit 205. The ROM 207 also stores, for example, a display control program for displaying various types of user interface (UI) screens on the display unit of the operation unit 204.

The controller unit 205 (for example, a CPU) reads out and executes programs stored in the ROM 207, carrying out various types of functions of the MFP 101 according to the first exemplary embodiment. The controller unit 205 interprets page description language (PDL) (hereinafter, it is assumed that the PDL is applied) data received from an external device via the external I/F 202, and rasterizes the data into raster image data (bitmap image data). Similarly, the controller unit 205 interprets and processes a print job received from an external device via the external I/F 202. Programs and other data for implementing such functions are also stored in the ROM 207.

The ROM 207 is a read-only memory, and stores in advance various types of programs, such as programs for a boot sequence and font information, and programs for carrying out the above-mentioned functions. The various types of programs stored in the ROM 207 will be described in detail below.

A random access memory (RAM) 208 is a memory from and to which data can be read and written, and stores, for example, image data sent from the scanner 201 or the external I/F 202, various types of programs, setting information, and other data.

The controller unit 205 also controls the operation of the sheet processing device 200. The sheet processing device 200 corresponds to the paper feeding device described with reference to FIG. 1.

The HDD 209 stores various data. For example, the HDD 209 stores image data compressed by a compression/decompression unit 206. The HDD 209 can also hold a plurality of data items, such as print data for a job to be processed.

The controller unit 205 stores data about a job to be processed, which is input via various types of input units, such as the scanner 201 and the external I/F 202, in the HDD 209, reads the data from the HDD 209, and outputs the data to the printer unit 203, causing the printer unit 203 to print the data. The controller unit 205 can transmit job data read from the HDD 209 to an external device via the external I/F 202. In this manner, the controller unit 205 executes various types of output processing, based on data about a job to be processed stored in the HDD 209.

The compression/decompression unit 206 compresses and decompresses image data stored in the RAM 208 and the HDD 209 in various types of compression methods, such as Joint Bi-level image experts Group (JBIG) and Joint Photographic Experts Group (JPEG).

A medium type detection unit 210 is disposed on a sheet transport path inside MFP 101, imaging a fed medium with a sensor, and determines the medium type from a resulting feature amount. The medium type determined by the medium type detection unit 210 is stored in the RAM 208 via the controller unit 205, and is also transmitted to an external device, such as the DFE 103 via the external I/F 202 as appropriate.

Further, the medium type in the present disclosure refers to a type obtained by classifying combinations of the surface properties (medium type) of media and the grammages of the media into certain ranges.

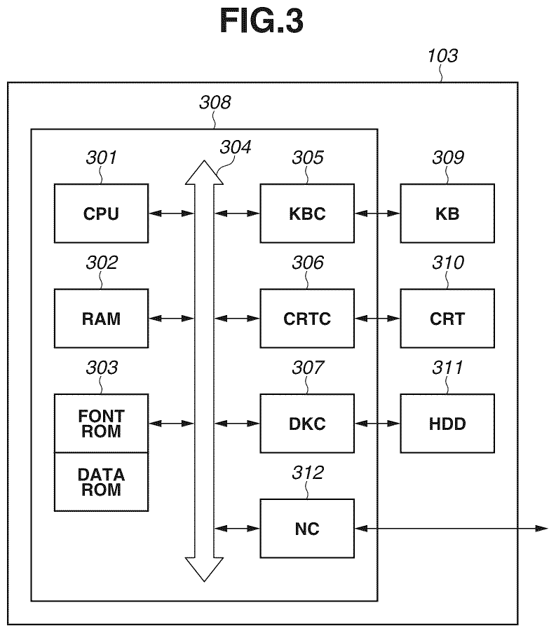

With reference to FIG. 3, an example of a hardware configuration of the DFE 103 according to the present exemplary embodiment will be described.

The CPU 301 loads various programs, such as an operating system (OS), general applications, and bookbinding applications, read from a program storage area (also referred to as a program ROM) in the ROM 303 or from an HDD 311 into a RAM 302 and executes the programs. The ROM 303 can be provided with a storage area for fonts (also referred to as a font ROM) and a storage area for data (also referred to as a data ROM). The RAM 302 functions as a main memory and a work area for the CPU 301.

A keyboard controller (KBC) 305 controls inputs from a keyboard (KB) 309 and a pointing device (not illustrated).

A display controller (CRTC) 306 controls display of various information on a display unit (CRT) 310.

A disk controller (DKC) 307 controls access (for example, reading and writing of data) to a storage device, such as the HDD 311 configured to store a boot program, various applications, font data, user files, for example.

A network controller (NC) 312 is connected to the network 100 and executes processing for controlling communications with other devices connected to the network 100.

A bus 304 connects the CPU 301 to the RAM 302, the ROM 303, various types of controllers and/or other devices, and transfers data signals and control signals transmitted and received between these components.

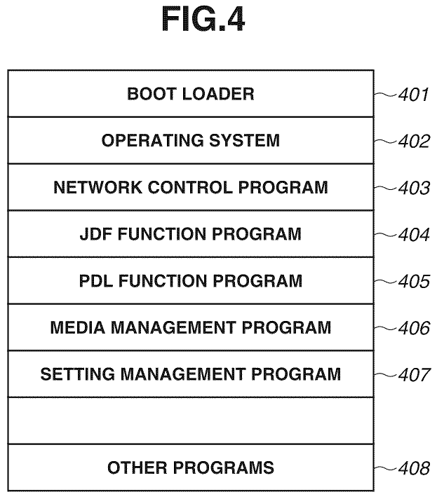

With reference to FIG. 4, an example of the software configuration of the MFP 101 according to the present exemplary embodiment will be described. A series of programs illustrated in FIG. 4 are stored in the ROM 207 and are read and executed by the controller unit 205 of the MFP 101.

A boot loader 401 is a program executed immediately after the MFP 101 is powered on.

The boot loader 401 includes programs for executing various types of start-up sequences for start-up of the system.

An operating system 402 is a program intended to provide an execution environment for various types of programs for carrying out the functions of the MFP 101. The operating system 402 mainly provides functions, such as resource management of the memory of the MFP 101, that is, the ROM 207, the RAM 208, and the HDD 209, and basic input/output control of each of the other components illustrated in FIG. 2.

A network control program 403 is a program executed when data is transmitted and received between devices connected via a network. The network control program 403 is used in receiving files to be printed, transmitting data to external devices, and transmitting and receiving commands. The network control program also includes a device driver program for controlling the external I/F 202.

A job definition format (JDF) function program 404 is a program for carrying out a JDF print function. The JDF function program 404 is executed by the controller unit 205 in response to an instruction from the external I/F 202 when JDF job data is received by the MFP 101 via the external I/F 202. In the JDF print function, the controller unit 205 sequentially instructs an operation of each device illustrated in FIG. 2 in an appropriate order, based on a processing order and processing condition described in the JDF function program 404. As a result, each device is controlled so that the JDF print processing is finally executed. The devices include the sheet processing device 200, the printer unit 203, the HDD 209, the compression/decompression unit 206, and the RAM 208. The JDF function program 404 also includes a program for performing analysis processing of JDF job data received via the external I/F 202, processing of determining whether the JDF contains any incorrect settings as a result of the analysis process, and a program for performing setting changes to clear the incorrect settings.

A function program 405 is a program for carrying out DL data loading processing and a printing function. The PDL function program 405 is executed by the controller unit 205 when PDL data (image data to be printed) is received by the MFP 101 via the external I/F 202. In the PDL function, the controller unit 205 sequentially instructs an operation of each device illustrated in FIG. 2 in an appropriate order, based on a processing order and processing condition described in the PDL function program 405. As a result, each device is controlled so that the PDL print processing is finally executed. The devices include the sheet processing device 200, the printer unit 203, the HDD 209, the compression/decompression unit 206, and the RAM 208. The PDL function program 405 in the present exemplary embodiment is configured to operate in cooperation with the JDF function program 404 as an analysis unit for various types of job setting formats in executing print processing.

A media management program 406 is a program for carrying out management functions for sheets that can be used by the MFP 101. The sheet-related information managed by the media management program 406 is stored in the HDD 209. The media management program 406 provides media management functions, such as registering new media and deleting unnecessary media. The media management program 406 also provides functions, such as changing the settings of a registered medium, adjusting an unadjusted medium, and re-registering the medium as an adjusted medium. The media management program 406 can carry out a management function, such as exporting medium information to an external device, such as the PC 102 via the external I/F 202, or importing medium information from an external device. As sheet-related information managed by the media management program 406, information about a print speed at which processing can be carried out during printing is linked and managed.

The JDF function program 404 and the PDL function program 405 work in cooperation with the media management program 406 to determine the type of a medium and printing conditions used by the job to be printed, and to select and control an appropriate printing speed.

A setting management program 407 is a program for configuring various types of settings of the MFP 101. An instruction to the setting management program 407 is performed via the operation unit 204 or is remotely performed from an external system, such as the PC 102 or the DFE 103 via the external I/F 202.

Other programs 408 schematically illustrates other programs not included in any of the above-mentioned programs, out of programs stored in the ROM 207 that can be executed by the MFP 101. The other programs 408 are not actively involved in carrying out the functions characterized by the present exemplary embodiment, and a detailed description thereof will be omitted.

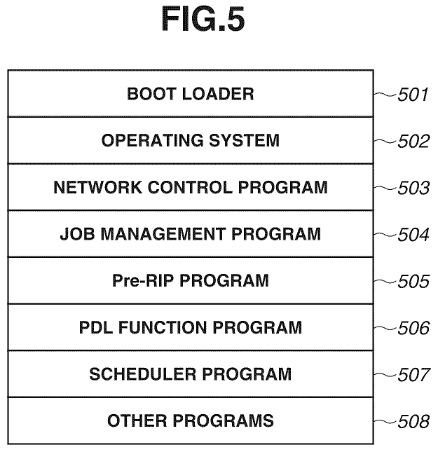

With reference to FIG. 5, an example of a software configuration of the DFE 103 according to the present exemplary embodiment will be described.

A boot loader 501 is a program executed immediately after the DFE 103 is powered on.

The boot loader 501 includes a program for executing various types of start-up sequences for start-up of the system.

An operating system 502 is a program intended to provide an execution environment for various types of programs for carrying out the functions of the DFE 103. The operating system 502 mainly provides functions, such as resource management of the memory of the DFE 103, that is, the ROM 303, the RAM 302, the HDD 311, and other memories.

A network control program 503 is a program executed when data is transmitted and received between devices connected via a network. The network control program 503 is used when print job data is transmitted to the MFP 101 and the MFP 101 is instructed to perform printing processing. The network control program 503 is also used for purposes, such as receiving print data from an external device, such as the PC 102, and transmitting statuses.

A job management program 504 is a program for managing the jobs transmitted by the DFE 103 to the MFP 101. With the job management program 504, it is possible to manage the job list in the order in which the jobs were sent, change the order of the jobs, and cause the DFE 103 to execute processing, such as pausing or canceling jobs and changing settings. When the DFE 103 receives a print job from an external device, such as the PC 102, the job management program 504 executes a series of job management and job execution control processing as the DFE 103. At this time, the job management program 504 operates in cooperation with a PDL function program 506, a scheduler program 507, a Pre-RIP program 505, and the like, which will be described below.

The Pre-RIP program 505 is a program for analyzing configuration information about the received print job data when the DFE 103 receives print job data from the PC 102 via the network control program 503. Specifically, the Pre-RIP program 505 collects the number of pages and page size of the print job data, the sheet information for each page, various types of setting information, and other information, and transmits such information to the job management program 504.

The PDL function program 506 is a program for performing processing of expanding the print job data, which is executed when the DFE 103 receives a print job from an external device, such as the PC 102, via the network control program 503. The expanded data is converted into a format suitable for printing and is sent to the MFP 101 via the network control program 503. Through this processing, the MFP 101 is instructed to execute the printing processing.

The scheduler program 507 is a program intended to present information on the progress of each job registered with the job management program 504. With the scheduler program 507, it is possible to display, on the display unit 310, a time taken for a job, and a time when no medium will occur, for example, in a chronologically understandable mode. This enables users of the MFP 101 and the DFE 103 to efficiently replenish media and to create production plans to produce print products.

Further, a device that mainly executes the scheduler program 507, such as the DFE 103, corresponds to an example of the information processing apparatus according to the present exemplary embodiment.

Other programs 508 schematically represent other programs not included in any of the above-mentioned programs among the programs included in the DFE 103. The other programs 508 are not actively involved in carrying out the functions characteristic of the present exemplary embodiment, and a detailed description thereof will be omitted.

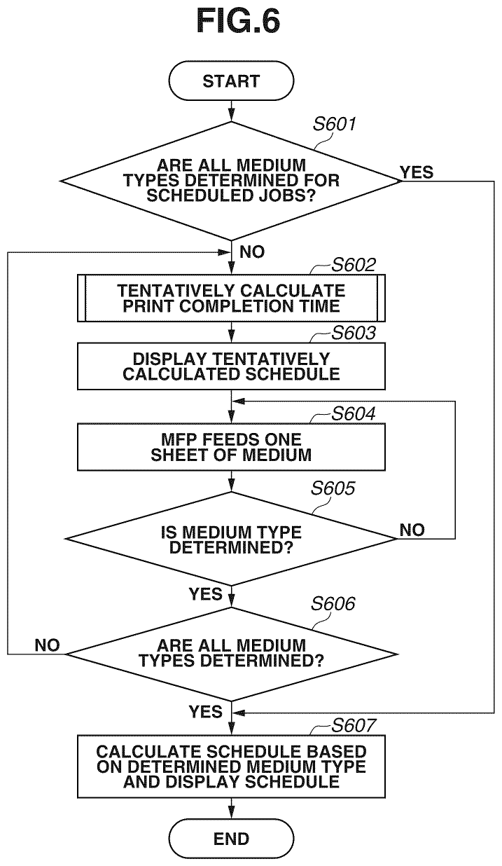

With reference to FIG. 6, an example of processing of the DFE 103 according to the present exemplary embodiment will be described, focusing in particular on processing for calculation and display of the print completion time of a job being executed, the processing of which is carried out by the scheduler program 507. The series of processing illustrated in FIG. 6 is started when one or more jobs are set in an execution queue by the job management program 504 of the DFE 103. In the example illustrated in FIG. 6, the actual processing is executed by DFE 103 (more specifically, the CPU 301), but to facilitate understanding of the characteristics, a description is provided so that such processing is executed by a program for performing the target processing.

In step S601, the scheduler program 507 checks whether all the medium types used in the jobs in the execution queue, that is, the scheduled jobs, are uniquely determined.

If the scheduler program 507 determines in step S601 that all the medium types used in the scheduled jobs are uniquely determined (Yes, in step S601), the processing proceeds to step S607.

On the other hand, if the scheduler program 507 determines in step S601 that none or not all of the medium types used in the scheduled jobs is or are uniquely determined (No, in step S601), the processing proceeds to step S602.

In step S602, the scheduler program 507 calculates the time for the scheduled jobs to be completed, based on the types of the media used in the jobs and the current state of the MFP. At this time, for an undetermined medium type, the scheduler program 507 calculates a tentative printing time from a user setting value (to be described below) and the medium types that could be set.

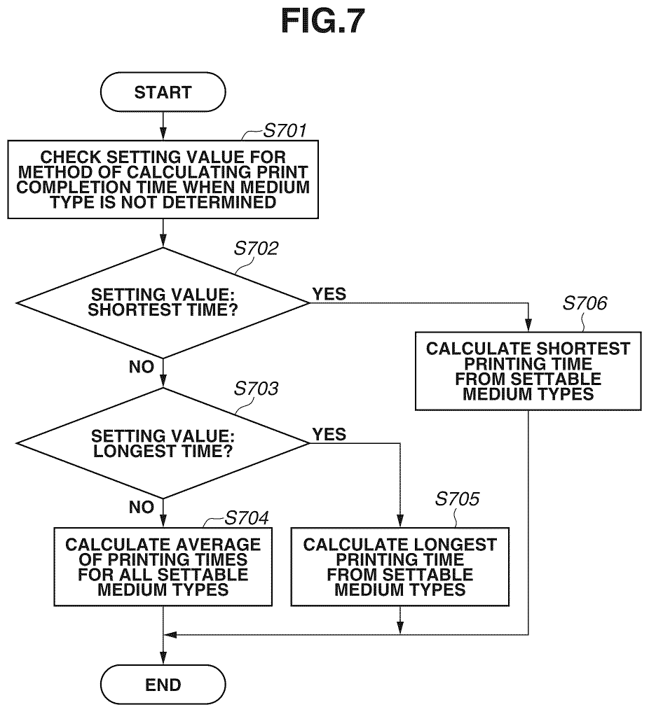

A method of calculating the tentative printing time will be described in detail below with reference to FIG. 7. The scheduler program 507 calculates the print completion time (time when the scheduled jobs are completed), including a tentative printing time, and then, the processing proceeds to step S603.

The medium type applied to calculate a tentative printing time (that is, a tentative medium type) corresponds to an example of a “reference medium type”.

In step S603, the scheduler program 507 displays the print completion time calculated in step S603 on the schedule screen. If a job with a medium as an undetermined type is included, the print completion time includes a tentative printing time. An example of the schedule screen will be described in detail below.

In step S604, the MFP 101 feeds one medium sheet. At this time, the medium being fed passes through a position where the medium type detection unit 210 is installed, and is detected by the medium type detection unit 210. The result of detection of the medium being fed by the medium type detection unit 210 allows a determination of the type of the medium.

In step S605, the scheduler program 507 determines whether the medium type left undetermined is determined. At this time, the DFE 103 may inquire of the MFP 101 about the medium type by polling processing, or the MFP 101 may notify the DFE 103 of the determined medium type.

If the scheduler program 507 determines in step S605 that the medium type left undermined is determined (Yes, in step S605), the processing proceeds to step S606.

On the other hand, if the scheduler program 507 determines in step S605 that the medium type left determined is not determined (No, in step S605), the processing proceeds to step S604. In such a case, the processing from step S604 onwards will be executed again.

In step S606, the scheduler program 507 determines whether all of the medium types left undetermined are determined.

If the scheduler program 507 determines in step S606 that all of the medium types left undetermined are determined (Yes, in step S606), the processing proceeds to step S607.

On the other hand, if the scheduler program 507 determines in step S606 that all of the medium types left undermined are not determined (No, in step S606), the processing proceeds to step S602. In such a case, the processing from step S602 onwards will be executed again.

In step S607, the scheduler program 507 calculates the print completion time based on the determined medium type, and displays the calculated print completion time on the schedule screen.

With reference to FIG. 7, an example of the processing for calculation of the tentative print completion time illustrated as the processing in step S602 in FIG. 6 will be described.

In step S701, the scheduler program 507 checks a setting value designated by the user for a setting regarding a method of displaying the print completion time when a medium of an undetermined type is included in a scheduled job. In the example illustrated in FIG. 7, as the setting value, either a setting value displaying the predicted shortest time, a setting value displaying the predicted longest time, or a setting value displaying an average printing time for all the possible medium types can be designated.

In step S702, the scheduler program 507 determines whether the setting value checked in step S701 is a setting value displaying the expected shortest time.

If the scheduler program 507 determines in step S702 that the target setting value is the setting value displaying the predicted shortest time (Yes, in step S702), the processing proceeds to step S706.

On the other hand, if the scheduler program 507 determines in step S702 that the target setting value is not the setting value displaying the predicted shortest time (No, in step S702), the processing proceeds to step S703.

In step S703, the scheduler program 507 determines whether the setting value checked in step S701 is the setting value displaying the predicted longest time.

If the scheduler program 507 determines in step S703 that the target setting value is the setting value that displays the predicted longest time (Yes, in step S703), the processing proceeds to step S705.

On the other hand, if the scheduler program 507 determines in step S703 that the target setting value is not the setting value displaying the expected longest time (No, in step S703), the processing proceeds to step S704.

In step S704, the scheduler program 507 replaces the undetermined medium type with a unique medium type (for example, a preset medium type) and calculates the printing time. At this time, the scheduler program 507 calculates the print completion time (scheduled job completion time) for each of a series of medium types that can be set, and sets the average as the tentative print completion time for the undetermined medium type.

In step S705, the scheduler program 507 replaces the undetermined medium type with a unique medium type (for example, a preset medium type) and calculates the printing time. At this time, the scheduler program 507 sets the print completion time for the medium type that takes the longest print completion time (scheduled job completion time) out of the series of medium types that can be set, as the tentative print completion time for the undetermined medium type.

In step S706, the scheduler program 507 replaces the undetermined medium type with a unique medium type (for example, a preset medium type) and calculates the printing time. At this time, the scheduler program 507 sets the print completion time for the medium type that takes the shortest print completion time (scheduled job completion time) out of the series of medium types that can be set, as the tentative print completion time for the undetermined medium type.

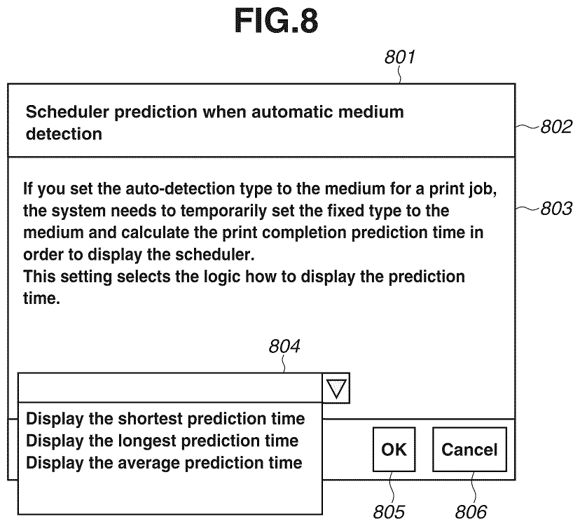

With reference to FIG. 8, an example of a setting screen for receiving, from a user, a designation of a setting regarding a method for displaying a print completion time when a scheduled job includes a medium of an undetermined type, as described in step S701 of FIG. 7, will be described. Specifically, a setting screen 801 illustrated in FIG. 8 corresponds to an example of a setting screen for receiving, from a user, a designation of a setting regarding calculation processing of the scheduler when a job including media to be automatically detected by the medium type detection unit 210 is executed.

The setting screen 801 is a screen for displaying various kinds of information for settings with which setting values can be designated, and for accepting a designation of the setting values from the user.

A field 802 is a display area in which the name of a setting subject to designation of a setting value is displayed.

A field 803 is a display area for displaying a detailed description of a setting subject to designation of a setting value.

A selection field 804 is a field for receiving a setting value designated from the user, a list of setting values the user can designate is displayed in a pull-down menu, and a designation of any setting value in the list is received from the user. Here, as described with reference to FIG. 7, a list of setting values is displayed that can be designated for a setting regarding a method for displaying a print completion time when a medium of an undetermined type (that is, a medium on which automatic detection is performed) is included in a scheduled job. Specifically, three setting values are displayed as the setting values to be designated: a setting value displaying the predicted shortest time, a setting value displaying the predicted longest time, and a setting value displaying an average printing time for all the medium types that can be set.

A decision button 805 is an input interface for receiving an instruction, from the user, to update the currently set setting value with the setting value designated via the selection field 804.

A cancel button 806 is an input interface for receiving an instruction, from the user, to cancel the update of the currently set setting values and to return the settings to the values that are present immediately before the setting screen 801 was opened.

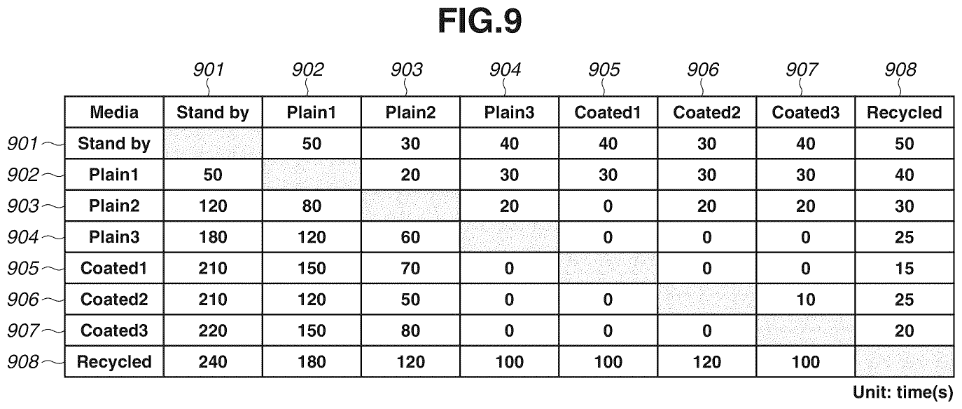

FIG. 9 illustrates an example of a management table indicating the time for MFP 101 according to the present exemplary embodiment to adjust the temperature of the fixing unit for the type of a medium to be used next when the type of a medium used for printing is switched during the printing. In an example illustrated in FIG. 9, the pieces of information about a medium type with different grammages are separately managed, and the candidates are distinguished by adding a number to the end of the name indicating the medium type.

A standby state 901 indicates that the MFP 101 is not currently in a printing state, and the temperature of the fixing unit is stable.

A plain paper 1 printing state 902 corresponds to a state in which plain paper 1 is being printed, in other words, a state in which the fixing unit is at a fixing temperature at which the plain paper 1 can be printed.

A plain paper 2 printing state 903 corresponds to a state in which plain paper 2 is being printed, in other words, a state in which the fixing unit is at a fixing temperature at which the plain paper 2 can be printed.

A plain paper 3 printing state 904 corresponds to a state in which plain paper 3 is being printed, in other words, a state in which the fixing unit is at a fixing temperature at which the plain paper 3 can be printed.

A coated paper 1 printing state 905 corresponds to a state in which coated paper 1 is being printed, in other words, the fixing unit is at a fixing temperature at which the coated paper 1 can be printed.

A coated paper 2 printing state 906 corresponds to a state in which coated paper 2 is being printed, in other words, the fixing unit is at a fixing temperature at which the coated paper 2 can be printed.

A coated paper 3 printing state 907 corresponds to a state in which coated paper 3 is being printed, in other words, a state in which the fixing unit is at a fixing temperature at which the coated paper 3 can be printed.

A recycled paper printing state 908 corresponds to a state in which recycled paper is being printed, in other words, a state in which the fixing unit is at a fixing temperature at which recycled paper can be printed.

In the example illustrated in FIG. 9, the series of states from the above-mentioned standby state 901 to the recycled paper printing state 908 are listed in both vertical and horizontal directions, with the states lined up vertically indicating states before switching and the states lined up horizontally indicating states after switching. That is, a value illustrated in a cell designated based on a vertical position determined based on a state before switching and a horizontal position determined based on a state after switching indicates the time to switch from the state before switching to the state after switching. In a specific example, it takes 30 seconds to switch from the plain paper 1 printing state 902 to the coated paper 3 printing state 907.

In the processing for calculating the tentative print completion time illustrated in FIG. 7, the longest time to switch media, the shortest time to switch media, or the average time to switch media is calculated based on the medium before and after a medium of an undetermined type. If there are two or more consecutive jobs of media with undetermined types, the time to switch the media can be calculated in general consideration of all the combinations of the medium types that can be designated for these jobs.

Further, a table illustrated in FIG. 9 is merely an example, and may be modified as appropriate according to the types of available media. In a specific example, more medium types than those illustrated in the example of FIG. 9 may be applied as candidates to be designated. In another example, a plurality of tables may be provided according to setting values.

If the printing speed differs according to the medium types before and after switching, the tentative print completion time is calculated taking into account the printing speeds according to the medium types before and after the switching and the time to switch the medium type.

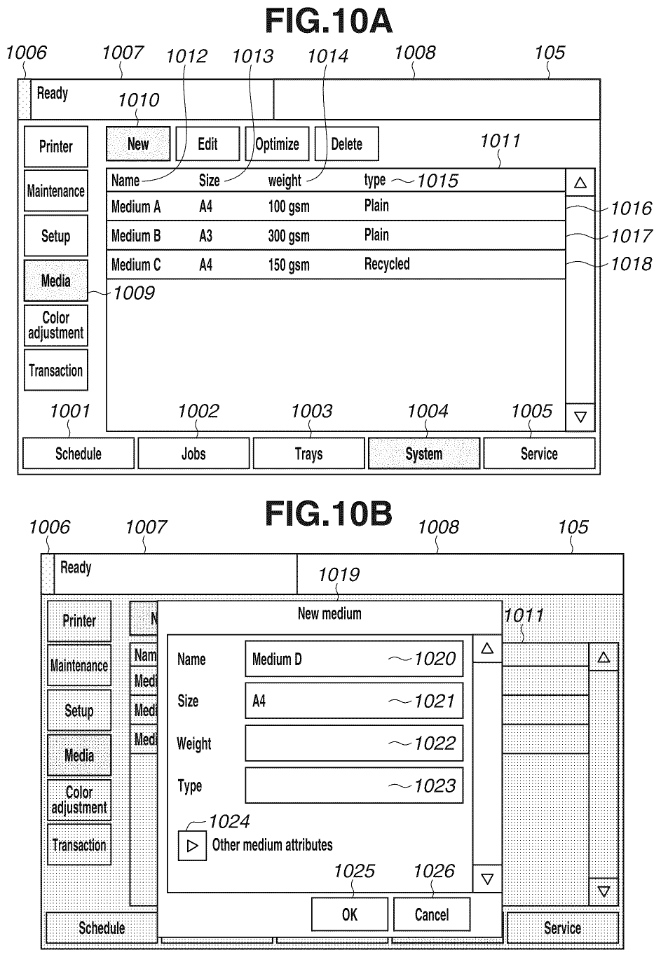

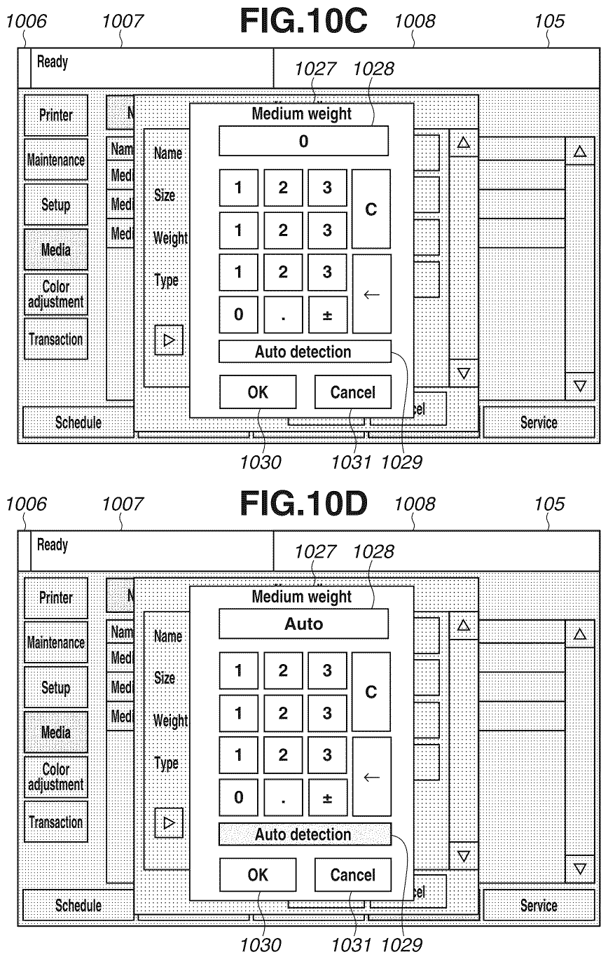

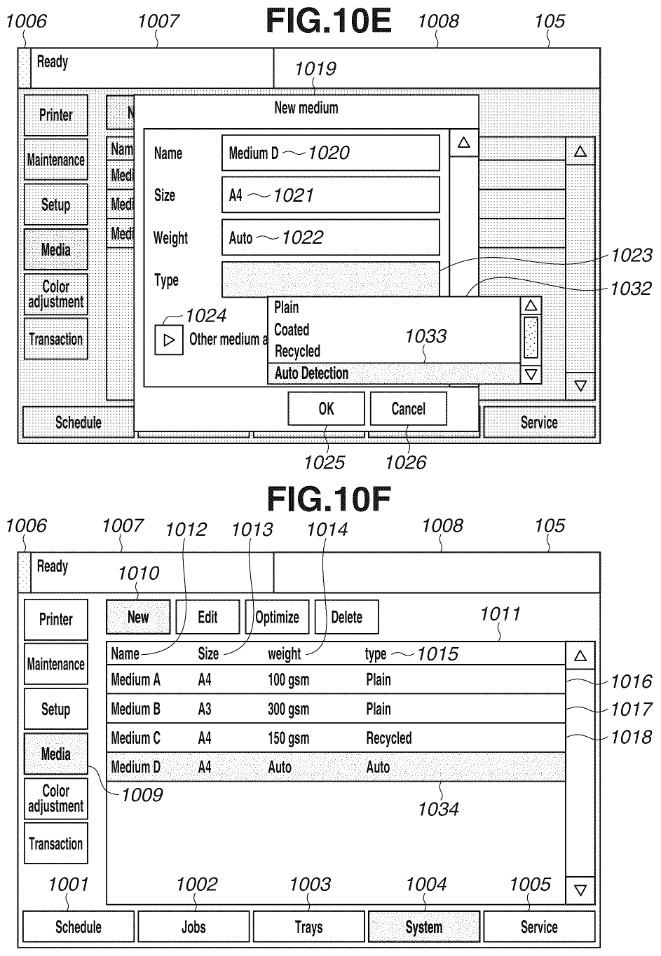

With reference to FIG. 10A to FIG. 10F, an example of a setting screen for media management presented to the user via the monitor 105 connected to the DFE 103 will be described.

FIG. 10A illustrates an example of a basic screen displayed on the monitor 105 connected to the DFE 103. First, with reference to FIG. 10A, an example of components of a screen common to the subsequent drawings and an operation method via the screen will be described.

At the top of the basic screen, various types of areas for displaying the status of the MFP 101 are arranged.

An alert notification area 1006 is a display area for notifying the user of a status of the MFP 101 with a display color variably controlled according to the status of the MFP 101 each time the display color changes.

A status display area 1007 is a display area for presenting a status of the MFP 101 to the user with text information. In an example illustrated in FIG. 10A, the status display area 1007 displays a character string “Ready” as information representing a normal state, an available state, and a non-operating state.

A detailed status display area 1008 is a display area for presenting more detailed information about a status of the MFP 101 to the user. Specifically, the detailed status display area 1008 is used as an area for displaying detailed information in situations where more detailed information is to be presented to the user in addition to a simplified display provided by the status display area 1007, such as when an error occurs. In the example illustrated in FIG. 10A, due to no error that occurs, no information is displayed in the detailed status display area 1008.

At the bottom of the basic screen, a plurality of input interfaces, such as buttons for selecting various types of operations of the MFP, is arranged.

A schedule setting button 1001 is an input interface for receiving an instruction, from the user, regarding a transition to a screen for setting and displaying scheduling information about a job to be executed by the MFP 101.

A job management button 1002 is an input interface for receiving an instruction, from the user, regarding a transition to a screen for configuring various types of settings for jobs executed by the MFP 101 and performing job queue operations.

A tray setting button 1003 is an input interface for receiving an instruction, from the user, regarding a transition to a screen to be operated when setting sheets in a plurality of paper feed units included in the MFP 101.

A system setting button 1004 is an input interface for receiving instructions, from the user, regarding transitions to execution screens for various types of functions for the overall system settings of the MFP 101.

A service execution button 1005 is an input interface for receiving instructions, from the user, regarding transitions to execution screens for various functions used when a maintenance on the MFP is performed.

The example illustrated in FIG. 10A illustrates a state in which the system setting button 1004 is pressed, and a state in which the function associated with a media management button 1009 is selected from among the functions selectable on the setting screen displayed by the system setting button 1004.

An example of functions and screen components associated with the media management button 1009 will be described.

A new media creation button 1010 is an input interface for receiving an instruction, from the user, for the creation of a new medium in the MFP 101 (more specifically, the creation of setting information for the new medium and the registration of the setting information).

A media list 1011 is an area in which a list of media registered with the MFP 101 is displayed. FIG. 10A illustrates an example of a state in which three media illustrated as media 1016, 1017, and 1018 (that is, media illustrated as Medium A, Medium B, and Medium C) are registered. The media list 1011 also includes display areas for each medium, such as a medium name 1012, a size 1013, a grammage 1014, and a medium type 1015, and information displayed in these display areas is updatable.

FIG. 10B illustrates an example of a screen state displayed immediately after the new media creation button 1010 is pressed in the state illustrated in FIG. 10A. In the example illustrated in FIG. 10B, a new medium information input screen 1019 is displayed, and the new medium information input screen 1019 displays input fields for a plurality of media-related attributes.

A medium name input field 1020 is a field for receiving an input of the name of a new medium from the user.

A media size input field 1021 is a field for receiving an input of the medium size of the new medium from the user.

A grammage input field 1022 is a field for receiving an input of the grammage of the new medium from the user.

A medium type input field 1023 is a field for receiving an input of the medium type of the new medium from the user.

Other media-related fields 1024 are a group of fields for receiving inputs from the user of other medium-related attributes not included in any of the series of input fields described above. A detailed description of the other medium-related fields 1024 will be omitted.

An OK button 1025 is an input interface for receiving an instruction, from the user, regarding the generation of the new medium. When the OK button 1025 is pressed, the processing of creating the new medium is started based on the contents entered in the series of input fields described above.

A cancel button 1026 is an input interface for receiving an instruction, from the user, to stop the processing of creating the new medium. When the cancel button 1026 is pressed, the contents entered in the series of input fields described above are cleared.

FIG. 10C illustrates an example of a screen transitioned when the grammage input field 1022 receives an operation from the user in the state illustrated in FIG. 10B. In such a case, a grammage input screen 1027 is displayed, and the currently set grammage is displayed in a display area 1028.

The grammage input screen 1027 displays an automatic grammage detection mode setting button 1029 in addition to a numeric keypad used for manually inputting a grammage value. When the automatic grammage detection mode setting button 1029 is pressed, the target medium is treated as a medium subject to automatic grammage detection. That is, in this case, the mode in which the grammage is automatically detected by the medium type detection unit 210 is applied.

An OK button 1030 is an input interface for receiving an instruction, from the user, to determine the input content. When the OK button 1030 is pressed, the input content in the grammage input screen 1027 is determined, and the screen transitions to the screen illustrated in FIG. 10B.

A cancel button 1031 is a button for receiving an instruction, from the user, to clear the input content. When the cancel button 1031 is pressed, the input content in the grammage input screen 1027 is cleared, and the screen transitions to the screen illustrated in FIG. 10B.

FIG. 10D illustrates an example of the grammage input screen 1027 when the automatic grammage detection mode setting button 1029 is pressed in the screen state illustrated in FIG. 10C. As illustrated in FIG. 10D, when the automatic grammage detection mode setting button 1029 is pressed, a character string “Auto” indicating that an automatic detection will be performed is displayed in place of the grammage value in the display area 1028 where a currently set grammage is displayed.

FIG. 10E illustrates an example of a screen state of the new medium information input screen 1019 immediately after the medium type input field 1023 accepts an operation in the screen state illustrated in FIG. 10B. As illustrated in FIG. 10E, a list 1032 of selectable medium types is displayed in the medium type input field 1023. In the example illustrated in FIG. 10E, out of the selectable medium type candidates displayed in the list 1032, a candidate 1033 indicating the setting of the automatic detection mode for a medium type (candidate with a display name “Auto Detection”) is selected. In this case, the target medium is treated as a medium subject to an automatic detection of a medium type. That is, in this case, the mode in which the medium type is automatically detected by the medium type detection unit 210 is applied.

The examples described with reference to FIG. 10D and FIG. 10E are illustrated in which settings of whether to subject a medium to automatic detections are configured individually for the medium grammage and the medium type, but a configuration in which the medium grammage and the medium type are set together can also be applied.

FIG. 10F illustrates an example of a basic screen (in this case, a setting screen for the media management) displayed as the result of the series of operations described with reference to FIG. 10A to FIG. 10E. In the example illustrated in FIG. 10F, a new medium candidate 1034 illustrated as “Medium D” is added to the media list 1011. For the medium candidate 1034, information is displayed that a mode is set in which automatic detections are performed for the medium grammage and the medium type.

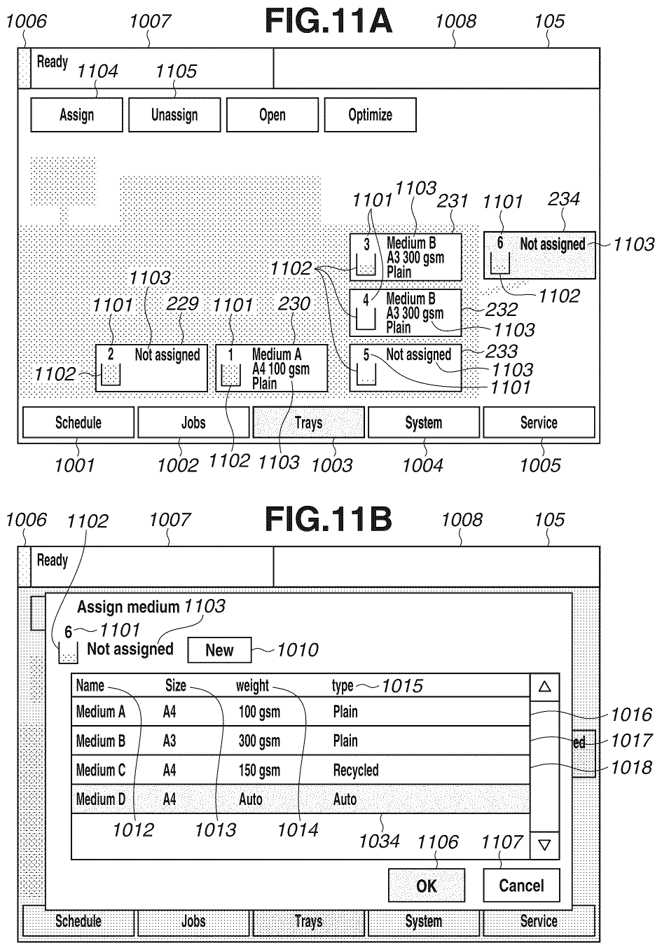

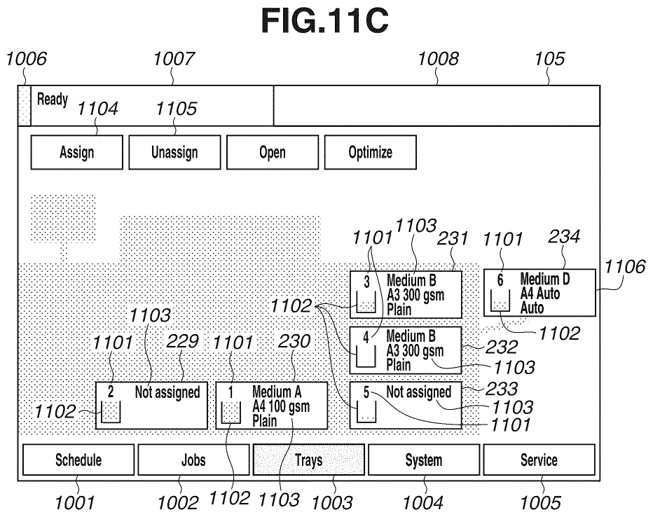

With reference to FIG. 11A to 11C, examples of management screens for the trays, which are supply sources of media, displayed on the monitor 105 connected to the DFE 103 will be described.

A management screen illustrated in FIG. 11A is displayed when the tray setting button 1003 is pressed on the basic screen illustrated in FIG. 10A.

A sheet setting button 1104 is an input interface for receiving an instruction, from the user, regarding the setting of a specific medium for a tray of the MFP 101.

A sheet setting release button 1105 is an input interface for receiving an instruction, from the user, to clear the medium setting(s) applied to a specific tray by an operation via the sheet setting button 1104.

The display areas corresponding to the paper feed units 230 to 234 are individually associated with the trays of the MFP 101. In the example illustrated in FIG. 11A, media are set in the trays associated with the paper feed units 230, 231, and 232, whereas no medium is set in the trays associated with the paper feed units 229, 233, and 234.

In the display area corresponding to each of the paper feed units 230 to 234, a tray number 1101, a remaining sheets graph 1102, and medium information 1103 are displayed as information about the associated tray. If no sheet is not set in a target tray, information indicating that no sheet is set (character string “Not assigned”) is displayed as the medium information 1103.

In the example illustrated in FIG. 11A, a tray 6 associated with the display area 234 (as the paper feed unit 234) is in a selected state. When the sheet setting button 1104 is pressed in this state, an instruction to set a medium to the tray 6 is received.

FIG. 11B illustrates an example of a screen displayed immediately after the sheet setting button 1104 is pressed in the state illustrated in FIG. 11A. In the screen illustrated in FIG. 11B, a list of medium candidates to be selected for setting a medium registered with the MFP 101 to the tray 6 associated with the display area 234 is displayed as the media list 1011. In the example illustrated in FIG. 11B, the medium candidate 1034 (Medium D) created by the operations described with reference to FIG. 10B to FIG. 10F and set for automatic detections is in a selected state. When the OK button 1106 is pressed in this state, Medium D is set to the tray 6, and the screen transitions to a screen illustrated in FIG. 11C. On the other hand, if a cancel button 1107 is pressed, Medium D is not set to the tray 6, and the screen transitions to the screen illustrated in FIG. 11A.

The method of selecting a medium to be set to a target tray via the screen illustrated in FIG. 11B is not limited to the method of selecting the medium candidate from the media list 1011. In a specific example, when the new media creation button 1010 is pressed in the screen illustrated in FIG. 11B and the operations described with reference to FIG. 10B to FIG. 10F are performed, a newly created medium can be set to the target tray.

FIG. 11C illustrates an example of a screen state transitioned immediately after the OK button 1106 is pressed in the screen state illustrated in FIG. 11B. As illustrated in FIG. 11C, Medium D, illustrated as the medium candidate 1034, is set to the tray 6 associated with the display area 234, based on the operation described with reference to FIG. 11B.

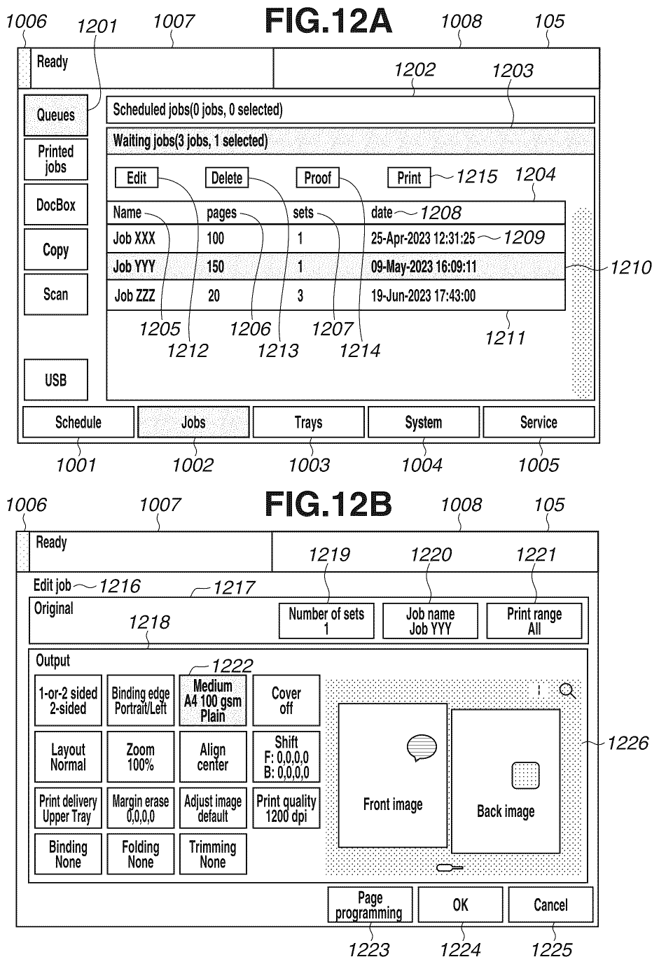

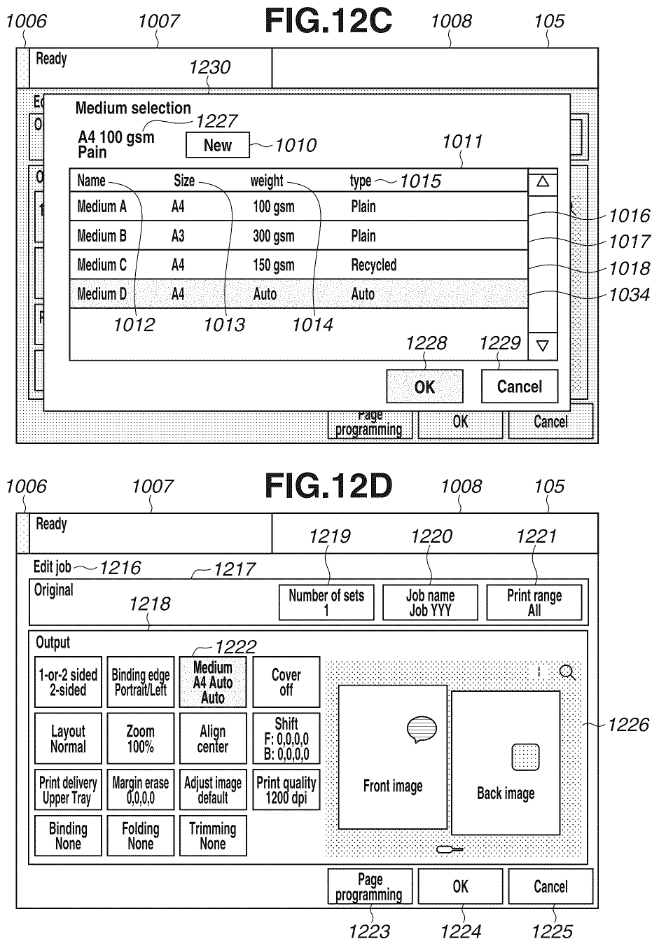

With reference to FIG. 12A to 12D, examples of management screens displayed on the monitor 105 connected to the DFE 103 will be described.

FIG. 12A illustrates an example of a job queue display screen in the job management screen, which is displayed on the monitor 105 connected to the DFE 103. The screen illustrated in FIG. 12A is displayed when a queue display button 1201 is pressed while the job management button 1002 is pressed. The constituent elements on the job queue display screen illustrated in FIG. 12A will be described.

A scheduled job queue selection area 1202 is an input/output interface for displaying a list of jobs with the printing processing in progress or jobs waiting for the execution, and for receiving a selection of a job included in the list from the user. With a job with the printing processing in progress or a job waiting for the execution, a list of those jobs is displayed in the scheduled job queue selection area 1202.

A waiting job queue selection area 1203 is an input/output interface for displaying a list of jobs stored or submitted to the DFE 103 and to which no instruction to execute the printing processing is issued, and for receiving a selection of a job included in the list from the user. With a job stored or submitted to the DFE 103 and to which no instruction to execute the print processing is issued, a list of such jobs is displayed in the waiting job queue selection area 1203.

The example illustrated in FIG. 12A illustrates a state in which the waiting job queue selection area 1203 is selected. In the example illustrated in FIG. 12A, jobs 1209, 1210, and 1211 are registered with a job list 1204 in the waiting job queue, and a job 1210 is in a selected state.

In the job list 1204, a job name 1205, a job page count 1206, a job set count 1207, and a job registration date and time 1208 are displayed.

A job setting edit button 1212 is an input interface for receiving an instruction, from the user, for a change to various types of job setting for a job selected in job list 1204.

A job deletion button 1213 is an input interface for receiving an instruction, from the user, to delete a job selected in the job list 1204.

A job verification button 1214 is an input interface for receiving an instruction, from the user, to execute processing for verifying, for example, a color tone of a portion of a printed product, the portion alone of which is printed based on the job selected in the job list 120 when the job verification button 1214 is pressed.

A job print button 1215 is an input interface for receiving an instruction, from the user, to move a job selected in the job list 1204 to a scheduled job queue to bring the job into a during-execution state or an execution standby state.

FIG. 12B illustrates an example of a job setting edit screen 1216 displayed when the job setting edit button 1212 is pressed on the screen illustrated in FIG. 12A, that is, when the job 1210 is in a selected state.

A first setting item 1217 includes an input interface for changing settings derived from job data, such as the number of copies, a job name, and a print range. In the example illustrated in FIG. 12B, input fields 1219, 1220, and 1221 correspond to the number of copies, a job name, and a print range, respectively.

A second setting item 1218 includes an input interface for changing various types of settings for the output in execution of a print job. In the example illustrated in FIG. 12B, an input area 1222 for changing a medium setting is included as an example of an input interface included in the second setting item 1218. In the example illustrated in FIG. 12B, “A4 100 gsm Plain” is set in the input area 1222 as the medium setting for the target job. This indicates that A4-sized plain paper of 100 grams per square meter is selected.

A finished-state confirmation area 1226 is an area where a preview of a finished state of an output product resulting from the application of the various types of job setting items selected via the second setting item 1218 is displayed.

A page programming button 1223 is an input interface for receiving, from the user, a designation of detailed settings for each of the pages constituting a print job different from the general settings for the job.

An OK button 1224 is a button for receiving an instruction, from the user, to transition to the job queue display screen illustrated in FIG. 12A after saving the various types of settings designated via the screen illustrated in FIG. 12B.

A cancel button 1225 is a button for receiving an instruction, from the user, to clear the various types of settings designated via the screen illustrated in FIG. 12A and transition to the job queue display screen illustrated in FIG. 12A.

FIG. 12C illustrates an example of a media setting screen 1230 displayed after the input area 1222 for changing the media setting is pressed in the screen state illustrated in FIG. 12B.

As described with reference to FIG. 12B, the medium setting for the target job is in a state where A4 size plain paper of 100 grams per square meter is selected, and the text “A4 100 gsm Plain” is displayed in the display area 1227 as information indicating the state.

A list of media registered with the MFP 101 is displayed in the media list 1011. If a medium candidate displayed in the list is selected, the medium corresponding to the candidate is set for the target job.

In the media list 1011, a medium name 1012, a size 1013, a grammage 1014, and a medium type 1015 are displayed for each medium candidate. In the example illustrated in FIG. 12C, the media 1016, 1017, 1018, and 1034 are displayed in a selectable state.

An OK button 1228 is an input interface for receiving an instruction, from the user, to transition to the screen illustrated in FIG. 12B after a media selected via the media list 1011 as a media for a target job is set.

A cancel button 1229 is an input interface for receiving an instruction, from the user, to clear the settings designated via the screen illustrated in FIG. 12C and transition to the screen illustrated in FIG. 12B.

In the example illustrated in FIG. 12C, Medium D illustrated as the medium candidate 1034 is in a selected state, and when the OK button 1228 is pressed in this state, Medium D is set as the medium type for the target job.

FIG. 12D illustrates an example of a screen state transitioned immediately after the OK button 1228 is pressed in the screen state illustrated in FIG. 12C. In the example illustrated in FIG. 12D, in the input area 1222 corresponding to the medium setting, it is indicated that the medium with the size of A4, the medium type, and the grammage set to automatic detections is set for the target job.

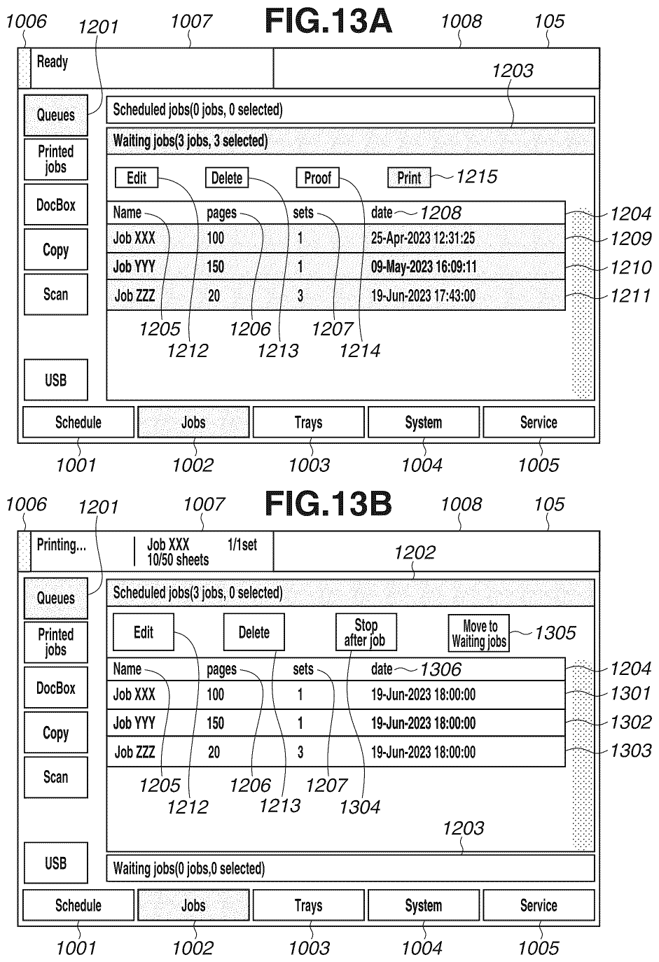

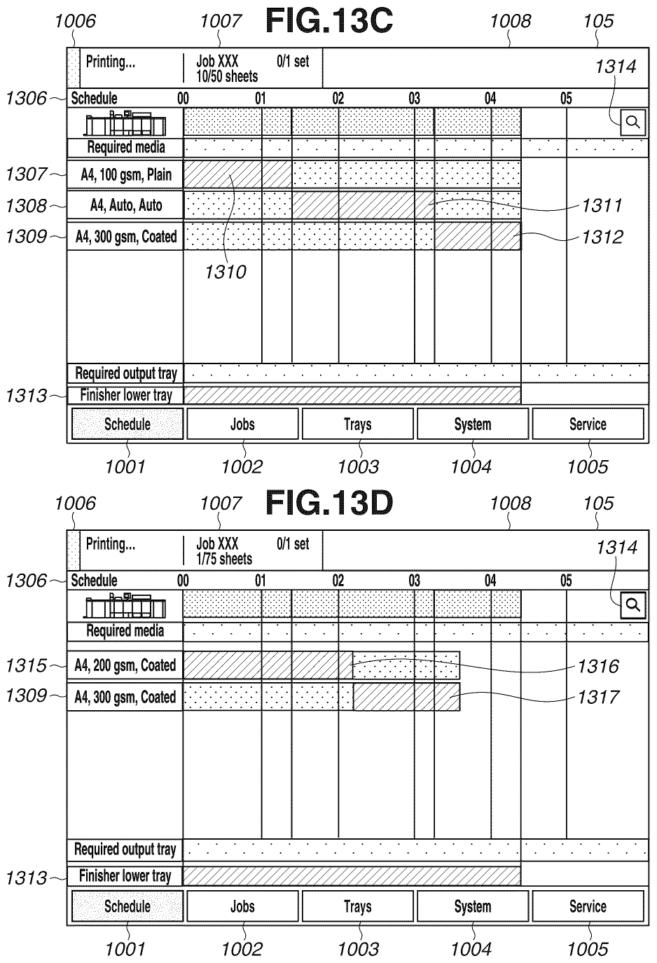

FIG. 13A and FIG. 13B illustrate examples of setting screens for a procedure for transitioning to a job execution state or an execution standby state, and the management of schedule settings, which are displayed on the monitor 105 connected to the DFE 103.

FIG. 13A illustrates an example of a job queue display screen in which the jobs 1209 to 1211 in addition to the job 1210 are in a selected state on the screen illustrated in FIG. 12A. When the job print button 1215 is pressed in the screen illustrated in FIG. 13A, the jobs 1209 to 1211 displayed in the waiting job queue selection area 1203 are moved to the scheduled job queue selection area 1202. As a result, the state of each of the jobs 1209 to 1211 transitions to a job execution state or an execution standby state.

FIG. 13B illustrates an example of a screen when the job print button 1215 is pressed in the state illustrated in FIG. 13A and then the scheduled job queue selection area 1202 is selected. Jobs 1301, 1302, and 1303 correspond to the jobs 1209, 1210, and 1211 illustrated in FIG. 13A, respectively, transitioned from a waiting state to a job execution state or an execution awaiting state.

Specifically, the job 1301 transitions to a job execution state, and information indicating that printing is in progress and the progress of printing is displayed in the status display area 1007.

The jobs 1302 and 1303 transition to a job execution standby state, and after printing the job displayed at the top in job list 1204 in the scheduled job queue is completed, the remaining jobs transition sequentially to a job execution state.

A print interruption button 1304 is an input interface for receiving an instruction, from the user, to temporarily interrupt the printing operation when the printing of a selected job is completed. When the print interruption button 1304 is pressed while a job displayed in the job list 1204 is selected, the printing operation is temporarily interrupted after the printing of the job is completed, and the execution of the next job is stopped.

A waiting job movement button 1305 is an input interface for receiving an instruction, from the user, to move a selected job from the scheduled job queue to the waiting job queue. The movement of a job from the scheduled job queue to the waiting job queue using the waiting job movement button 1305 is effective for jobs in an execution awaiting state.

FIG. 13C illustrates an example of a schedule screen displayed when the schedule setting button 1001 is pressed after a job transitions to an execution state and an execution standby state as illustrated in FIG. 13B.

A schedule time display area 1306 displays information indicating passages of time until the printing of jobs in execution states and in standby states is completed.

Each of the requested media 1307 to 1309 indicates a medium used in a job in an execution state or an execution awaiting state. The requested media 1307 to 1309 are displayed from the top in the order from the earliest requested time.

Print schedules 1310 to 1312 are associated with the requested media 1307 to 1309, respectively, and display information indicating times taken to print on target requested media. Specifically, in the example illustrated in FIG. 13C, information indicating the time taken to complete the printing on the requested medium 1307, that is, A4-sized plain paper of 100 grams per square meter, is displayed as the print schedule 1310. Information indicating the time taken to complete the printing on the requested medium 1308, that is, an A4 medium whose type is an automatic detection, is displayed as the print schedule 1311. Similarly, information indicating the time taken to complete the printing of the requested medium 1309, that is, A4 coated paper of 300 grams per square meter, is displayed as the print schedule 1312.

In the print schedule 1311, which is a schedule for the medium whose medium type is set to an automatic detection, and in the immediately preceding print schedule 1312, whose medium type is undetermined, the time tentatively calculated in the processing of step S602 in FIG. 6 is displayed.

A requested tray display area 1313 is an area in which information indicating the discharge destination of a medium designated in a job in an execution state or in a standby state is displayed from the top in the order from the earliest requested time.

A scale change button 1314 is an input interface for receiving an instruction, from the user, to change the scale of a time axis displayed in the schedule time display area 1306.

FIG. 13D illustrates an example of the schedule screen illustrated in FIG. 13C immediately after the printing of the job 1301 illustrated in FIG. 13B is completed and the medium type in the job 1302, which is an automatic detection, passes through the medium type detection unit 210.

In a requested medium 1315, the requested medium 1308, whose medium type is set to an automatic detection, passes through the medium type detection unit 210, and the medium type is determined and updated to A4 coated paper of 200 grams per square meter.

Print schedules 1316 and 1317 are print schedules after the print schedules 1311 and 1312, which are displayed based on the results of the tentative calculation in FIG. 13C, are updated with recalculated times based on the determined medium type. The processing of recalculating a printing time based on the determined medium type and updating the display based on the result of the recalculation corresponds to the processing of step S607 illustrated in FIG. 6.

As described above, the printing system according to the present exemplary embodiment enables displaying a print schedule based on a tentatively calculated printing time even in a situation where the medium type is not determined at the start of the job. When the medium type is determined, the printing time is recalculated based on the determined medium type, and the printing schedule is updated based on the result, allowing display of a more accurate printing schedule.

A second exemplary embodiment will be described. In the first exemplary embodiment described above, the example has been described in which, when the scheduled job includes a medium of an undetermined type, the print completion time to be displayed is the longest, shortest, or the average print completion time selected by the user. On the other hand, if the user is able to designate a medium type to some extent, in some cases, a more accurate schedule can be displayed by the undetermined medium type being replaced with a medium tentatively set by the user through a calculation of the print schedule. In the second exemplary embodiment of the present disclosure, as an example of an operation of the printing system in such a case, focusing in particular on processing for a tentative calculation of a schedule including an undetermined medium type, a procedure of such processing and an example of a setting screen presented to the user at the time will be described.

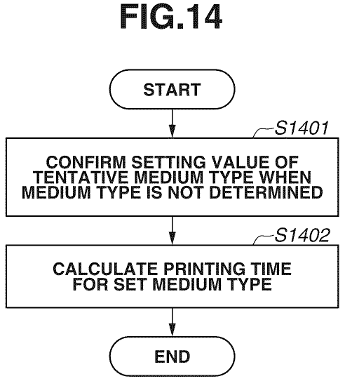

The example of the processing of the printing system according to the present exemplary embodiment will be described with reference to FIG. 14, focusing in particular on the calculation processing of a tentative print completion time. The processing corresponds to the processing of step S602 illustrated in FIG. 6.

In step S1401, when the scheduled job includes a medium of an undetermined type, the scheduler program 507 confirms the user-set value of the tentative medium type used in the calculation processing of the printing time.

In step S1402, the scheduler program 507 calculates the printing time on the assumption that the tentative medium type confirmed in step S1401 is applied as the undetermined medium.

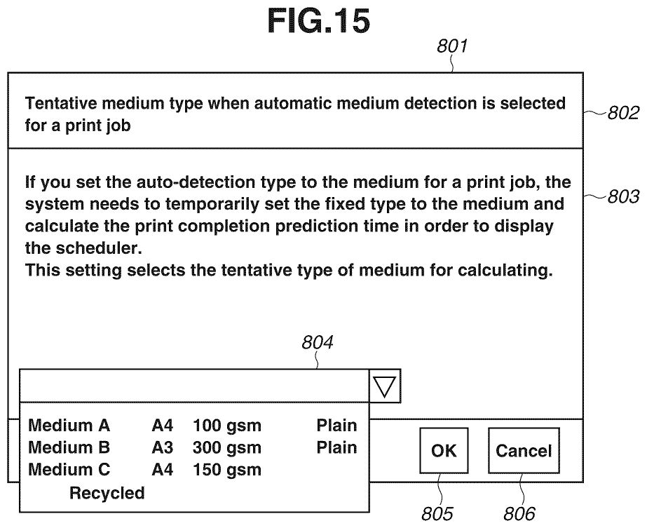

An example of the setting screen allowing the user to set the tentative medium type for a job including a medium automatically detected by the medium type detection unit 210, as described in step S1401, will be described with reference to FIG. 15.

In the example illustrated in FIG. 15, a selection field 804 for selecting a user setting value displays options for tentative medium types to be used in the calculation processing of the printing time when a medium of an undetermined type is included in the scheduled job. In calculating the tentative print completion time, the candidates for the type of a medium expected to be used may differ by tray. In such a case, a setting screen, such as the setting screen illustrated in FIG. 15, can be provided for each tray so that the user setting value for a temporary medium can be selected for each tray.

As described above, the printing system according to the present exemplary embodiment sets a tentative medium type selected by the user, calculates the printing time, and displays the printing schedule. Such control is expected to produce an effect allowing a more accurate printing schedule (in other words, a printing schedule that is less different from the actual printing schedule) as a tentative schedule to be presented to the user.

A third exemplary embodiment will be described. In the first exemplary embodiment described above, the example has been described of the case where the tentative schedule calculation is performed for a medium of an undetermined type, and the tentative schedule is displayed based on the result (for example, the example illustrated in FIGS. 13C and 13D). On the other hand, as mentioned above, if a job with an undetermined medium type is included, the schedule for printing on the job and the schedules for printing on other jobs following the job will be tentative schedules based on a tentatively calculated printing time. In this way, in a situation where a tentative schedule is likely to be set, there are cases where a determined schedule based on the medium type designated in a job and an undetermined schedule (tentative schedule) based on a tentatively calculated printing time due to an undetermined medium type are mixed. In view of such a situation, in the third exemplary embodiment of the present disclosure, an example will be described in which a determined schedule and an undetermined schedule (for example, a tentative schedule with an undetermined medium type) are displayed in different forms such that these schedules can be distinguished from each other.

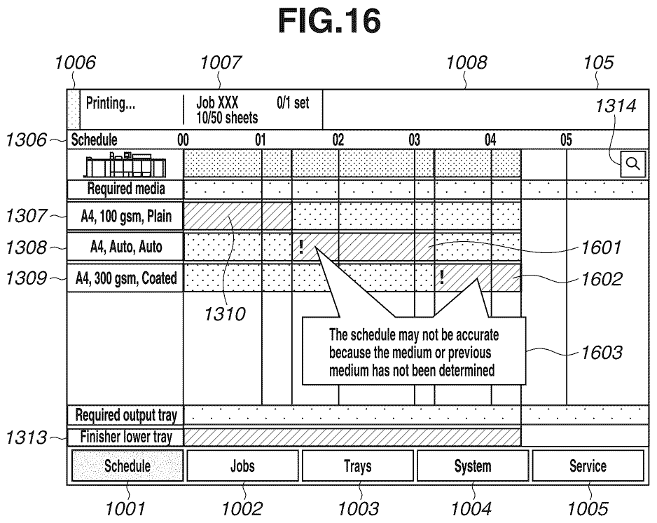

FIG. 16 illustrates an example of a setting screen for management of schedule settings and transition procedures to a job execution state or an execution standby state in a printing system according to the present exemplary embodiment. In the example illustrated in FIG. 16, a determined schedule and an undetermined schedule are displayed in different forms such that the user can distinguish these from each other.

Specifically, the example in FIG. 16 illustrates a case where the type of a medium to be targeted in a print schedule 1601 is not determined, displaying the schedule as tentative with a changed display color and an added mark.

A print schedule 1602 is displayed with a changed displayed color and an added mark since the print schedule 1601 to be executed immediately before the print schedule 1602 is tentative due to the undetermined medium type.

In the example illustrated in FIG. 16, a description field 1603 is displayed in association with the print schedules 1601 and 1602. The description field 1603 displays a description indicating that the associated schedules (that is, the print schedules 1601 and 1602) are tentative. This allows the user to recognize that the print schedules 1601 and 1602 associated with the description field 1603 are tentative (that is, undetermined schedules).

As described above, the printing system according to the present exemplary embodiment provides a determined schedule and an undetermined schedule in different forms. This enables a user to easily distinguish between determined and undetermined schedules based on the presentation form of each schedule (for example, the display color and the presence or absence of a mark).

A fourth exemplary embodiment will be described. In the first exemplary embodiment, the example has been described in which when a scheduled job includes a medium of an undetermined type, the method of displaying the print completion time is selected from among the longest, the shortest, and the average, depending on the user setting value. In contrast, in the fourth exemplary embodiment of the present disclosure, an example will be described of a case where the shortest time and the longest time for printing to be completed are displayed together as a schedule. Specifically, in the present exemplary embodiment, an example will be described of a case where a schedule with the range from the shortest time to the longest time is displayed for a scheduled job with a medium of an undetermined type.

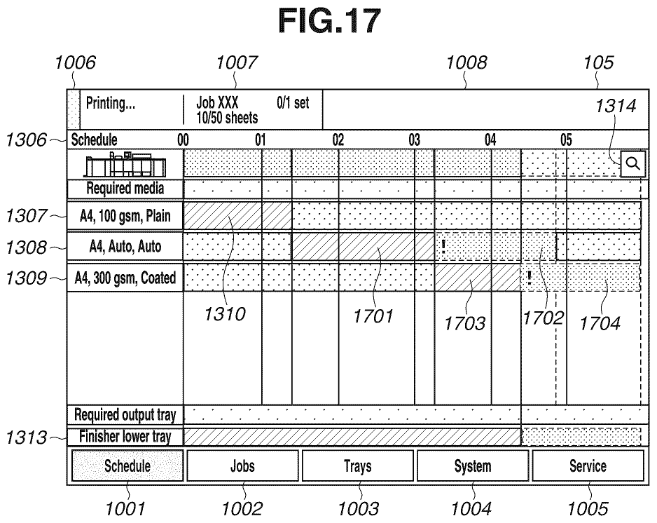

FIG. 17 is a diagram illustrating an example of a setting screen for managing schedule settings, the screen on which a tentative printing schedule according to the present exemplary embodiment is displayed, and particularly illustrates an example of a case of displaying a tentative printing schedule with the range from the shortest time to the longest time.

Shortest time print schedules 1701 and 1703 indicate the schedules in which a requested medium 1308 subject to an automatic detection of the medium type will take the shortest time to be printed in combination with the other requested media 1307 and 1309.

Shortest time print schedules 1702 and 1704 indicate the schedules in which the requested medium 1308 subject to an automatic detection of the medium type will take the longest time to be printed in combination with the other requested media 1307 and 1309.

When a schedule job includes a medium of an undetermined type, the control described above allows a schedule with the range from the shortest time to the longest time to be displayed.

A fifth exemplary embodiment will be described. In the first exemplary embodiment, an example has been described in which when a scheduled job includes the medium of an undetermined type, the method of displaying the print completion time is selected from among the longest, the shortest, and the average, depending on the user setting value. On the other hand, there may be a situation where the display of an undetermined schedule confuses the user. In view of such a situation, in the fifth exemplary embodiment of the present disclosure, an example will be described of a case where when a scheduled job includes the medium of an undetermined type, the display of the schedule(s) after the job is restricted (for example, the schedule(s) is or are not displayed).

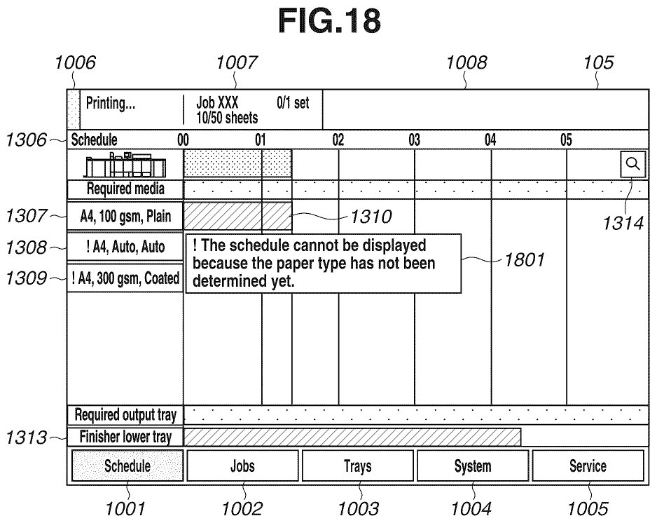

FIG. 18 is a diagram illustrating an example of a setting screen for management of schedule settings in the present exemplary embodiment, and particularly illustrates an example of a case where the display of the schedule(s) for a job with a medium of an undetermined type and the job(s) following the job is restricted. Specifically, in the example illustrated in FIG. 18, the requested media 1308 is subject to an automatic detection of a medium type, so that the medium type is undetermined. As a result, the schedule after the requested medium 1308 is not displayed.

In the example illustrated in FIG. 18, a description field 1801 is displayed in association with the requested medium 1308 of an undetermined type and a requested medium 1309 on which printing is executed after the requested medium 1308. In the description field 1801, information is displayed that the schedule for the requested media (that is, the requested media 1308 and 1309) cannot be displayed until the undetermined medium type is determined.

When the medium type of the requested medium 1308 of an undetermined medium type is determined, the schedule in a restricted display following the schedule with the requested media 1308 is displayed based on the determined medium type.

As described above, when a scheduled job includes a medium of an undetermined type, the printing system of the present exemplary embodiment restricts the display of the schedule(s) following the job and displays the schedule(s) after the medium type is determined. The control is expected to produce an effect avoiding confusing a user due to the display of an undetermined schedule.

According to the present exemplary embodiment, even in a situation where the type of a medium to be used in printing is undetermined, a predicted time until the printing is completed can be provided in a more suitable manner.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-175152, filed Oct. 10, 2023, which is hereby incorporated by reference herein in its entirety.

What is claimed is:

1. A printing system comprising:
a reception unit configured to receive a print job in which a type of a medium to be used in printing is able to be designated;
a schedule management unit configured to calculate, based on the type of the medium designated in the print job, a time until the printing on the print job is completed, and output the calculated time to a predetermined output destination; and
a detection unit configured to detect a type of a medium fed by a feeder,
wherein when there is no type of medium designated in the print job, the schedule management unit calculates the time until the printing on the print job is completed based on a previously set reference medium type, and outputs the calculated time to the output destination, and
wherein when the type of medium is determined based on a detection result of the medium fed in the print job, the schedule management unit updates, based on the type of the medium, the time until the printing is completed and the time being output to the output destination.

2. The printing system according to claim 1, wherein when no medium type is designated in the print job, the schedule management unit calculates the time until the printing is completed using each of settable types of a series of media as the reference medium type, and outputs, as the time until the printing is completed to the output destination, an average of a plurality of the times calculated with the types of the series of media.

3. The printing system according to claim 1, wherein when no medium type is designated in the print job, the schedule management unit outputs, to the output destination, the time until the printing is completed, the time being a shortest of times taken with settable types of a series of media that are each set as the reference medium type.

4. The printing system according to claim 1, wherein when no medium type is designated in the print job, the schedule management unit outputs, to the output destination, the time until the printing is completed, the time being a longest of times taken with settable types of a series of media that are each set as the reference medium type.

5. The printing system according to claim 1,
wherein when no medium type is designated in each of a plurality of print jobs to be continuously executed, the schedule management unit calculates the time until the printing on is completed on each of the plurality of print jobs with each combination of types of a series of media that are settable to each of the plurality of print jobs, each of the types of the series of media being set as the reference medium type, and based on the time calculated with each combination of the types of the series of media, determines the time until the printing is completed, the time being to be output to the output destination.

6. The printing system according to claim 5, wherein the schedule management unit calculates the time until the printing is completed on each the plurality of print jobs with each combination of different types of the series of media, the time including a time to switch between types of the series of media.

7. The printing system according to claim 1, wherein the schedule management unit controls the time until the printing is completed, the time being to be output to the output destination and to be presented in forms different between before the type of the medium is determined and after the type of the medium is determined.

8. The printing system according to claim 1, wherein the schedule management unit calculates, under each of a plurality of different conditions from each other, the time until the printing is completed as a candidate on each of one or more print jobs, each job in which no type of a medium is designated, and outputs the time until the printing is completed as the candidate calculated under each of the plurality of different conditions, to the output destination.

9. An information processing apparatus comprising:
a reception unit configured to receive a print job in which a type of a medium to be used in printing is able to be designated; and
a schedule management unit configured to calculate, based on the designated type of medium for the print job, a time until the printing on the printing job is completed, and output the calculated time to a predetermined output destination,
wherein when no medium type is designated in the print job, the schedule management unit calculates the time until the printing on the printing job is completed, based on a previously set reference medium type, and outputs the calculated time to the output destination, and
wherein when the medium type is determined based on a detection result of the medium fed in the print job, the schedule management unit updates the time until the printing is completed, the time being output to the output destination based on the type of the medium.

10. A method of controlling an information processing apparatus, the method comprising:
receiving a print job in which a type of a medium to be used in printing is able to be designated; and
performing schedule management by managing a schedule by calculating, based on the medium type designated in the print job, a time until the printing on the print job is completed, and outputting the calculated time to a predetermined output destination,
wherein performing the schedule management includes, when no medium type is designated in the print job, the time until the printing on the print job is completed is calculated based on a previously set reference medium type, and the calculated time is output to the output destination, and
wherein performing schedule management includes, when the medium type is determined based on a detection result of the media fed in the print job, the time until the printing is completed, the time being output to the output destination, is updated based on the type of the medium.

11. A non-transitory computer readable storage medium for storing a program causing an information processing apparatus to perform a method, the method comprising:
receiving a print job in which a type of a medium to be used in printing is able to be designated; and
performing schedule management by managing a schedule by calculating, based on the medium type designated in the print job, a time until the printing on the print job is completed, and outputting the calculated time to a predetermined output destination,
wherein performing the schedule management includes, when no medium type is designated in the print job, the time until the printing on the print job is completed is calculated based on a previously set reference medium type, and the calculated time is output to the output destination, and
wherein performing schedule management includes, when the medium type is determined based on a detection result of the media fed in the print job, the time until the printing is completed. the time being output to the output destination, is updated based on the type of the medium.
